(19) United States
(12) Patent Application Publication
(10) Pub. No.: US 2025/0386359 A1
(43) Pub. Date: Dec. 18, 2025

(54) INFERRING THE PRESENCE OF ULTRA-WIDEBAND SESSIONS

(71) Applicant: QUALCOMM Incorporated, San Diego, CA (US)

(72) Inventors: Varun Amar REDDY, San Diego, CA (US); Aleksandar DAMNJANOVIC, Del Mar, CA (US); Krishna Kiran MUKKAVILLI, San Diego, CA (US)

(21) Appl. No.: 18/742,484

(22) Filed: Jun. 13, 2024

(51) Int. Cl. H04W 72/51; H04W 72/12; H04W 72/541

(52) U.S. Cl. CPC H04W 72/51; H04W 72/12; H04W 72/541

(57) ABSTRACT

A Network Entity for inferring a presence of Ultra-wideband (UWB) sessions within a zone of interest. An example Network Entity comprises: at least one transceiver; at least one memory; and at least one processor, in signal communication with the at least one transceiver, and the at least one memory, the at least one processor configured to: receive, with the at least one transceiver, a plurality of UWB session reports from a plurality of user equipment (UEs) within the zone of interest, wherein each UWB session report includes an indication of UWB activity in a vicinity of a corresponding UE; generate a heatmap of the zone of interest by aggregating the plurality of UWB session reports; and schedule transmission, reception, or both, of non-interfering non-UWB signals in the zone of interest.

### BACKGROUND

Ultra-wideband (UWB) is a wireless technology that utilizes wideband radio waves and can use very low energy levels for short-range, high-bandwidth communications over a large portion of the radio spectrum. UWB signal energy may be transmitted without interfering with narrowband and carrier wave transmission in the same frequency band. Compared to Wi-Fi or BLUETOOTH® communications, UWB operates in higher frequency bands and uses a wider bandwidth (i.e., 500 megahertz or more). These special characteristics of UWB allow it to measure distance and determine position much more accurately than other technologies, providing the basis for building more secure applications. In general, UWB has applications in non-cooperative radar imaging, target sensor data collection, precise locating, tracking, and digital car keys. At present, the UWB spectrum is presently divided into channels 1-15 spanning frequencies from about 3.5 GHz to about 4.5 GHz and from about 6.5 GHz to about 10 GHz.

In addition to UWB communication systems, future cellular communication systems, such as, for example, future 5G and 6G systems, are also planning on utilizing a frequency spectrum that includes about 7 GHz to 24 GHz. As such, there may issues of interference between the UWB spectrum and the planned future cellular frequency spectrum as both types of systems coexist within the 7 GHz to 10 GHz frequency band.

### SUMMARY

Techniques are discussed for a Network Entity for inferring a presence of Ultra-wideband (UWB) sessions within a zone of interest for coexistence with non-UWB such as, for example, cellular signals. An example Network Entity comprises: at least one transceiver; at least one memory; and at least one processor, in signal communication with the at least one transceiver, and the at least one memory, the at least one processor configured to: receive, with the at least one transceiver, a plurality of UWB session reports from a plurality of user equipment (UEs) within the zone of interest, wherein each UWB session report includes an indication of UWB activity in a vicinity of a corresponding UE; generate a heatmap of the zone of interest by aggregating the plurality of UWB session reports; and schedule transmission, reception, or both, of non-interfering non-UWB signals in the zone of interest.

Also discussed are methods for inferring a presence of UWB sessions within a zone of interest for coexistence with non-UWB signals with a Network Entity. An example method may include receiving, with the at least one transceiver, a plurality of UWB session reports from a plurality of user equipment (UEs) within the zone of interest, wherein each UWB session report includes an indication of UWB activity in a vicinity of a corresponding UE; generating a heatmap of the zone of interest by aggregating the plurality of UWB session reports; and scheduling transmission, reception, or both, of non-interfering non-UWB signals in the zone of interest.

Other techniques are also discussed for a Network Entity for inferring a presence of UWB sessions within a zone of interest for coexistence with none-UWB signals. Another example of the Network Entity comprises: means for receiving, with an at least one transceiver, a plurality of UWB session reports from a plurality of user equipment (UEs) within the zone of interest, wherein each UWB session report includes an indication of UWB activity in a vicinity of a corresponding UE; means for generating a heatmap of the zone of interest by aggregating the plurality of UWB session reports; and means for scheduling transmission, reception, or both, of non-interfering non-UWB signals in the zone of interest.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a simplified diagram of an example wireless communications system.

FIG. 2 is a system block diagram of components of an example user equipment (UE) shown in FIG. 1.

FIG. 3 is a system block diagram of components of an example transmission/reception point shown in FIG. 1.

FIG. 4 is a system block diagram of components of an example server shown in FIG. 1.

FIG. 5 is a functional system block diagram of an example of an implementation of a first ranging device and a second ranging device configured to communicate with each other over an Ultra-wideband (UWB) spectrum.

FIG. 6 is a functional system block diagram of an example of an implementation of an ranging device and a plurality of ranging devices acting as anchors conformally located around an automobile in accordance with the present disclosure.

FIG. 7 is a functional system block diagram of an example of an implementation of a frequency operated button (FOB) and a plurality of anchors conformally located around an automobile in accordance with the present disclosure.

FIG. 8 is a frequency plot of a UWB frequency band and a future 5G New Radio (NR) frequency band.

FIG. 9A is an example of a message flow diagram illustrating roles that different ranging devices may assume within a UWB ranging session.

FIG. 9B is another example of a message flow diagram illustrating roles that the different ranging devices may assume within the UWB ranging session.

FIG. 10 is a signal time diagram illustrating how time may be segmented and utilized within a UWB positioning session.

FIG. 11 is a signal flow diagram of communications between a first ranging device and a second ranging device.

FIG. 12 is a functional system block diagram illustrating an example of a cluster of anchors.

FIG. 13 is a system block diagram of an example of an implementation of a Network Entity, a user equipment (UE), and a plurality of anchors conformally located around an automobile in a zone of interest.

FIG. 14 is a system block diagram of an example of an implementation of a heatmap illustrating UWB session activity over a zone of interest.

FIG. 15 is a sequence diagram illustrating an example of an implementation of operation of the Network Entity shown in FIG. 13.

FIG. 16 is a flowchart of a method of operation of the Network Entity shown in FIG. 13.

FIG. 17 is a flowchart of a method of operation of the UE shown in FIG. 13.

### DETAILED DESCRIPTION

Techniques are discussed for a Network Entity for inferring a presence of Ultra-wideband (UWB) sessions within a zone of interest, e.g., for coexistence with non-UWB signals such as, for example, cellular signals. In general, these techniques are directed to techniques/protocols for receiving UWB session reports within the zone of interest, generating a heatmap of the zone of interest by aggregating the UWB session reports, and scheduling transmission, reception, or both, of non-interfering non-UWB signals in the zone of interest. As an example, the schedule of transmission may be transmitted to at least one base station that is configured to transmit the non-UWB signals to the zone of interest and a plurality of user equipments (UEs) within the vicinity of the zone of interest. In general, the zone of interest may include one or more UWB zones.

In one embodiment, crowdsourcing the UWB session reports from International Mobile Telecommunications (IMT) of the International Telecommunication Union (ITU) UEs may be utilized to allow a server (e.g., the Network Entity) to infer the presence and locations UWB zones of UWB activity. The UWB zones can be stored at the Network Entity for future use in scheduling IMT transmission in the vicinity of the UWB zones, this scheduling may include messages within in the Long-Term Evolution (LTE) Positioning Protocol (LPP) that is the result of the received UWB session reports.

In these examples, the cellular signals may be, for example, non-UWB signals such as future 5G and 6G signals (i.e., transmission standards proposed by the IMT operating within a frequency band of about 7 GHz to 10 GHz, herein referred to simply as “IMT” signals) that may cause interference with UWB signals. The proposed solution may include modifying Section 6.5 of the TS 37.355 (LPP) standard specification.

Utilizing these techniques, a Network Entity for inferring a presence of UWB sessions within a zone of interest for coexistence with non-UWB signals (e.g., cellular signals) is discussed. The Network Entity may comprise: at least one transceiver; at least one memory; and at least one processor, in signal communication with the at least one transceiver, and the at least one memory, the at least one processor configured to: at least one transceiver; at least one memory; and at least one processor, in signal communication with the at least one transceiver, and the at least one memory, the at least one processor configured to: receive, with the at least one transceiver, a plurality of UWB session reports from a plurality of user equipment (UEs) within the zone of interest, wherein each UWB session report includes an indication of UWB activity in a vicinity of a corresponding UE; generate a heatmap of the zone of interest by aggregating the plurality of UWB session reports; and schedule transmission, reception, or both, of non-interfering non-UWB signals in the zone of interest.

Also discussed is a UE for inferring a presence of UWB sessions within a zone of interest for coexistence with non-UWB signals where an example UE comprises: at least one transceiver; at least one memory; and at least one processor, in signal communication with the at least one transceiver, and the at least one memory, the at least one processor configured to: receive, with the at least one transceiver, at least one UWB session configuration messages within the zone of interest; create a UWB session report from the received UWB session configuration messages; and transmit, with the at least one transceiver, the UWB session report to a Network Entity.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

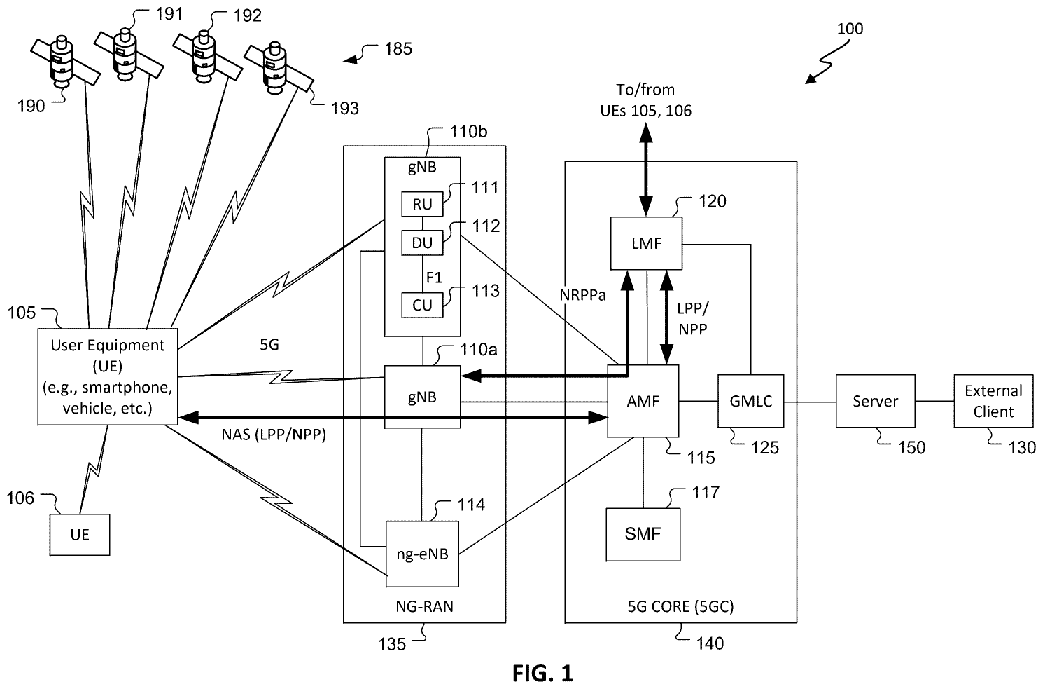

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP Inter Working Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some implementations, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

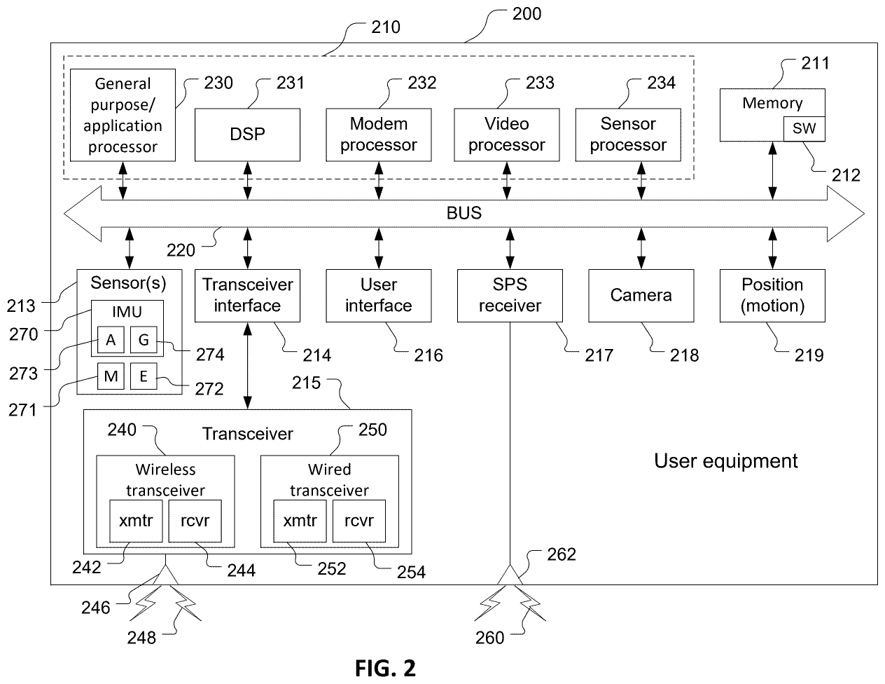

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a GPS receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

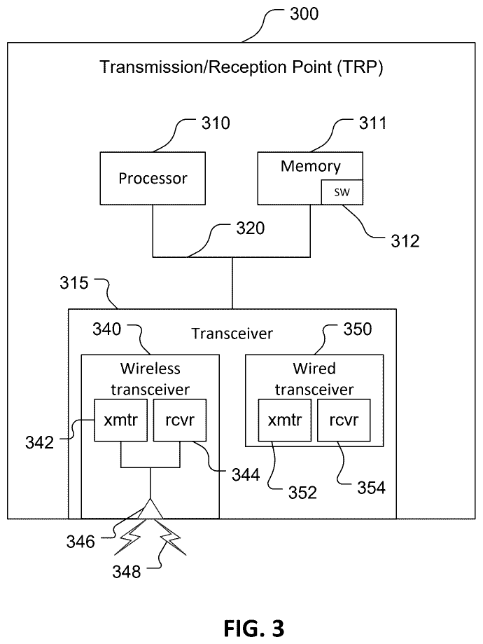

Referring also to FIG. 3, an example of a TRP 300 of the gNBs 110a, 110b and/or the ng-eNB 114 may comprise a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

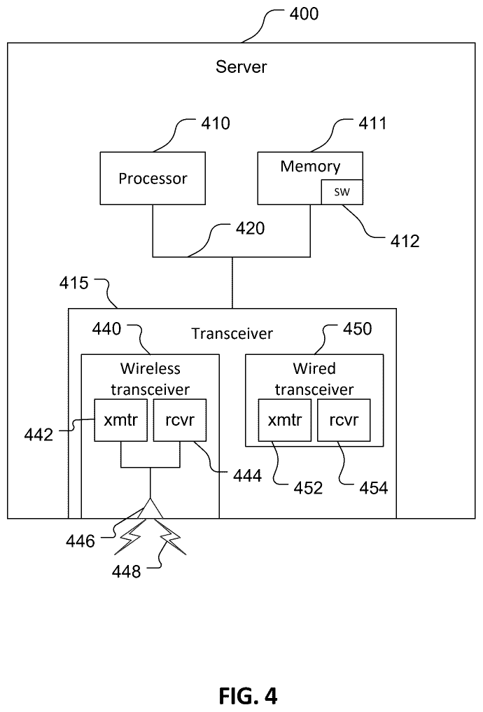

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_(Rx→Tx) (i.e., UE_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_(Tx→Rx) between the transmission time of the RTT measurement signal from the base station and the ToA of the RTT response at the base station to the UE-reported time difference T_(Rx→Tx), and subtracting the UE_{Rx-Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

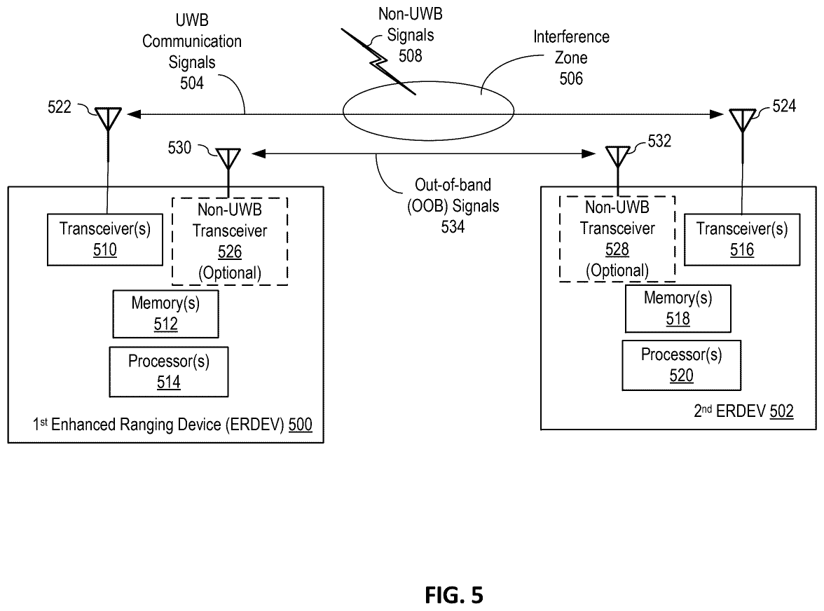

Turning to FIG. 5, a system block diagram is shown of an example of an implementation of a first UWB device (i.e., enhanced ranging device 500) and a second ranging device 502 configured to communicate with each other over the UWB spectrum. The first ranging device 500 and second ranging device 502 are each UWB devices. In this example, the first ranging device 500 and second ranging device 502 are configured to perform transmissions and retransmissions of UWB communication signals 504 between the UWB devices (i.e., the first ranging device 500 and second ranging device 502) with potential channel hopping to help avoid potential signal interference in an interference zone 506 caused by non-UWB signals 508 transmitting within the interference zone 506. The non-UWB signals 508 may be, for example, IMT signals (e.g., future 5G and 6G signals) operating within the about 7 GHz to 10 GHz frequency spectrum.

In examples discussed, the UWB devices may use pulse-based radio signaling (e.g. Short-pulse-UWB) instead of OFDM-based signaling (Multi-Band OFDM UWB). Short-pulse-UWB signaling transmits with the energy for each bit spread over the entire UWB channel bandwidth (e.g., 1.37 GHz, 4 GHZ, etc.) with varying pulse amplitude and/or pulse polarity without using a RF carrier while MB-OFDM (Multi-Band-OFDM) transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT), but may use time-domain or space-time processing techniques. Short-pulse-UWB may utilize various shapes (e.g. Gaussian pulses, Monocycle pulses, Hermite pulses, etc) and the shape used may be chosen based on their properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high speed Analog-to-Digital converter (ADC) and a high speed Digital-to-Analog Converter (DAC) to be able to handle the very wide frequency band used; however, there may be other ways to handle the need for ultra-fast sampling such as using Time Hopping techniques, Direct Sequence coding techniques, etc.

Multiband OFDM UWB divides up spectrum into several frequency sub-bands and OFDM is applied within each band; whereas, other OFDM systems typically operate within a fixed frequency band. The complex waveform created by combining the multiple-sub-bands results in a final waveform that used for transmission for Multiband OFDM UWB. Multiband OFDM UWB also varies from other OFDM systems by not using a guard interval, using simpler modulation schemes like Binary Phase Shift keying (BPSK) or Quadrature phase-shift keying (QPSK) vs. 64 or 256 Quadrature Modulation (QAM), utilizes a constant power level whereas other OFDM systems may utilize power control for varying channel conditions, etc.

In general, the first ranging device 500 may include at least one transceiver 510, at least one memory 512, and at least one processor 514 in signal communication with the at least one transceiver 510, and the at least one memory 512. Similarly, the second ranging device 502 may include at least one transceiver 516, at least one memory 518, and at least one processor 520 in signal communication with the at least one transceiver 516, and the at least one memory 518. In this example, the first ranging device 500 may also include at least one antenna 522 and the second ranging device 502 may include at least one antenna 524 to transmit and receive the UWB communication signals 504. The first ranging device 500 and second ranging device 502 may each also optionally include a non-UWB transceiver (i.e., non-UWB transceiver 526 for the first ranging device 500 and non-UWB transceiver 528 for the second ranging device 502) in signal communication with an optional non-UWB antenna (i.e., non-UWB antenna 530 for the first ranging device 500 and non-UWB antenna 532 for the second ranging device 502). In this example, the optional non-UWB transceiver 526 and non-UWB transceiver 528 may communicate via out-of-band (OOB) signals 534 between the non-UWB antenna 530 and non-UWB antenna 532 of the first ranging device 500 and second ranging device 502, respectively. As an example, the OOB signals may be any narrow band type signals such as, for example, BLUETOOTH® or Wi-Fi® signals.

In this example, the optional non-UWB transceiver 526 and non-UWB antenna 530 may be part of, or optionally separate devices from, the at least one transceiver 510 and at least one antenna 522. Similarly, the optional non-UWB transceiver 528 and non-UWB antenna 532 may be part of, or optionally separate devices from, the at least one transceiver 516 and at least one antenna 524. In this example, the non-UWB transceiver 526, non-UWB antenna 530, non-UWB transceiver 528, and non-UWB antenna 532 may also optionally be part of the at least one transceiver 510, at least one antenna 522, at least one transceiver 516, and at least one antenna 524, respectively.

In an example of operation, the at least one processor 514 of the first ranging device 500 may transmit to the second ranging device 502 an RCM (i.e., a ranging control message) to schedule a UWB ranging session between the first ranging device 500 and the second ranging device 502. The RCM may be transmitted either by the at least one transceiver 510, via the UWB communications signals 504, or by the optional non-UWB transceiver 526 via the OOB signals 534.

As an example, the UWB ranging session may include a plurality of consecutive ranging blocks, where each ranging block includes a plurality of ranging rounds, and each ranging round includes a plurality of ranging slots. The schedule may include a hopping pattern for the plurality of ranging rounds and/or ranging slots. The at least one processor 514 may also be configured to transmit a ranging initiation message (RIM) on a first ranging slot and retransmit the RIM on a different ranging slot utilizing the hopping pattern.

In this example, each ranging slot may have a slot duration that is equal to between approximately 1 millisecond (ms) and approximately 2.66 ms, and the RIM may include a data packet that has a packet duration that is equal to approximately 150 microseconds.

The circuits, components, modules, and/or devices of, or associated with the first ranging device 500 and second ranging device 502, and other devices are described as being in signal communication, communicatively coupled, and/or electrically coupled (or simply “coupled”) with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information may be passed from one circuit, component, module, and/or device to another in varying digital formats without passing through a direct electromagnetic connection.

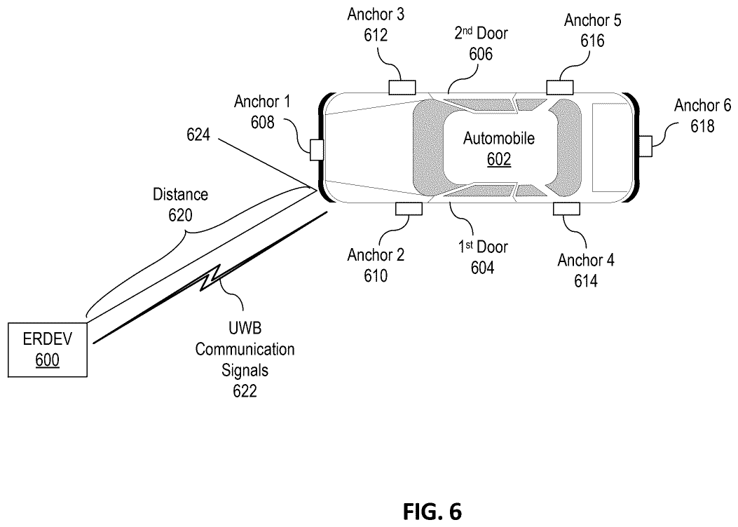

In FIG. 6, a system block diagram is shown of an example of an implementation of a ranging device 600 and a plurality of ranging devices (i.e., a cluster) acting as anchors conformally located around an automobile 602. In this example, the automobile 602 may include a first door 604 and second door 606 (on a first and a second side of the automobile 602) and the plurality of ranging devices may include, for example, six anchors that include a first anchor 608, second anchor 610, third anchor 612, fourth anchor 614, fifth anchor 616, and sixth anchor 618. As an example, the first anchor 608 and sixth anchor 618 may be located at the front and back of the automobile 602 and the second anchor 610 and fourth anchor 614 may be located on the first side of the automobile 602 and the third anchor 612 and fifth anchor 616 may be located on the second side of the automobile 602 opposite the first side. In this example, the second anchor 610 and the fourth anchor 614 may be located in front and in back of the first door 604 and the third anchor 612 and the fifth anchor 616 may be located in front and in back of the second door 606. In this example, as previously described, the six anchors are anchor devices (referred to herein as “anchors,” “UWB anchors,” or “tags”) that may include UWB devices with known locations that can be used to determine the position of the ranging device 600 using UWB signals. As an example, the UWB positioning may be performed utilizing relevant standards (e.g., IEEE 802.15.4ab), which enable high-accuracy, low-power positioning.

The ranging device 600 may be a key with a frequency operated button (generally referred to as a keyFOB or simply a “FOB”) and/or UE that is utilized to unlock the first door 604 and second door 606 individually or together based on the distance 620 of the ranging device 600 to the automobile 602 and/or individual plurality of anchors based on the range (i.e., the distance 620) and location of the ranging device 600 relative to the automobile 602. In this example, the distance 620 between the automobile 602 and ranging device 600 is based on the measurements of the UWB communication signals 622 between the ranging device 600 and plurality of anchors.

In this example, the ranging device 600 may be, for example, a FOB and/or a module, component, or application of a mobile device such as, for example, a UE. With the known positions of the six anchors (i.e., first anchor 608, second anchor 610, third anchor 612, fourth anchor 614, fifth anchor 616, and sixth anchor 618), the determination of a location of the ranging device 600 can be made by determining the corresponding distances (not shown but approximately equal to the distance 620 between the ranging device 600 and a point 624 on the automobile 602 plus the individual distances from the point 624 to the locations of the individual anchors along the automobile 602) between the individual anchors and the ranging device 600. These distances (i.e., between the ranging device 600 and the individual anchors) can be determined using a variety of positioning-related measurements and/or procedures that may include, for example, Reference Signal Time Difference (RSTD), ToA (i.e., time of arrival), two-way ranging (TWR) (e.g., single-sided TWR (SS-TWR) and/or double-sided TWR (DS-TWR)), TDOA, and more. Additionally, or alternatively, angle-based measurements may also be made for positioning of the ranging device 600, including angle of arrival (AoA) and/or Angle of departure (AoD).

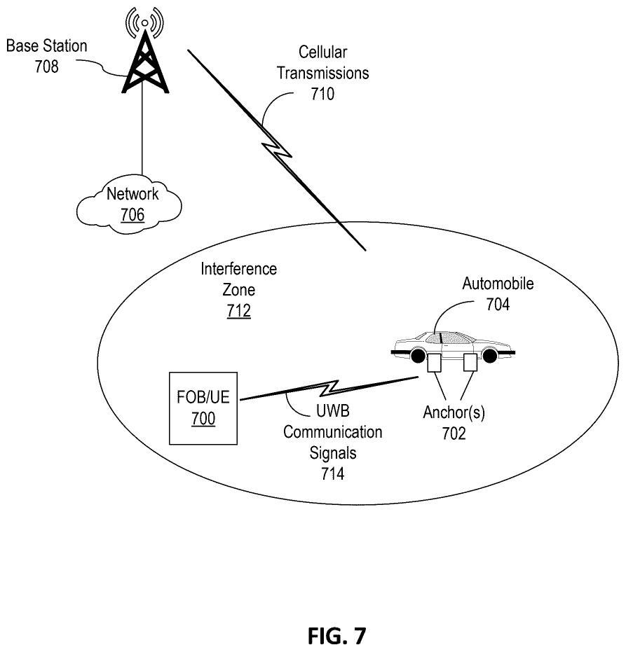

Turning to FIG. 7, a system block diagram is shown of an example of an implementation of a FOB 700 (or UE) and a plurality of anchors 702 conformally located around an automobile 704. This example is similar to the example shown in relation to FIG. 7, except that in this example, the area around the FOB 700 and plurality of anchors 702 experiences signal interference from a cellular network 706. Specifically, the cellular network 706 is in signal communication with a cellular tower (i.e., a base station 708) that emits cellular transmissions 710 (e.g., IMT signals) towards the area where both the FOB 700 and plurality of anchors 702 are located causing an interference zone 712 around the FOB 700 and plurality of anchors 702. In this example, the cellular transmission 710 may cause interference (within the interference zone 712) with the UWB communication signal 714 between the FOB 700 and plurality of anchors 702.

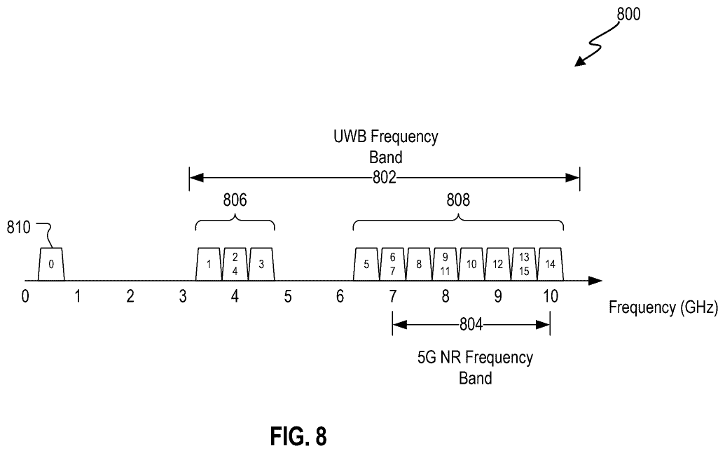

In FIG. 8, a frequency plot 800 is shown of UWB frequency band 802 and future 5G next radio (NR) frequency band 804 (i.e., IMT band). In this example, the UWB frequency band 802 (from 3.1 GHz to 10.6 GHz) contains channels 1-14 within a low band 806 and a high band 808, respectively, with the UWB frequency band 802 being well above a sub-GHz band 810 and the channels 1-14 spanning respective frequency bands. In this example, the future 5G NR frequency band 804 is shown to span UWB channels 6-15 of the high band 808.

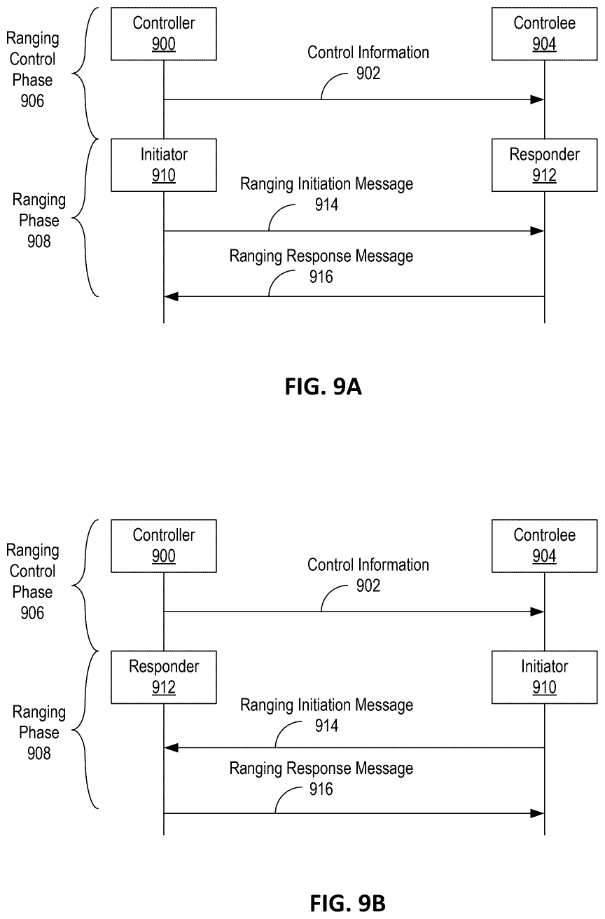

FIG. 9A is a message flow diagram illustrating the roles different devices may assume with regard to a UWB ranging session (or simply a “UWB session”), which may be conducted in accordance with a relevant UWB positioning standard (e.g., IEEE 802.15.4ab). As discussed earlier, each UWB device may be a ranging device. The ranging devices may be referred to with different terminologies (e.g. initiator/responder or controller/controlee) at different layers of the network stack. The terms initiator and responder (described hereafter) may be used at lower layers (e.g., at UWB physical (PHY) and media access control (MAC) layers), while the terms controller and controlee (also described hereafter) may be used at higher layers (e.g., an application layer of the ranging devices).

In this example, the controller is a ranging device that controls the ranging and defines the ranging parameters by sending an RCM (i.e., the Ranging Control Message). In general, the RCM may be a data packet utilized for control purpose that could be transmitted via the UWB communication signals 104 (shown in FIG. 1) or over another narrow band signal such as, for example, the OOB signal 134 (shown in FIG. 1) that may be, for example, BLUETOOTH® or Wi-Fi®. The ranging parameters may be updated during an ongoing ranging session by sending a Ranging Control Update Message (RCUM). The controlee is an ranging device that utilizes the ranging parameters received from the controller in the RCM. Once the control message is provided to the controlee, both the controller and controlee know when to transmit a UWB packet and over what channel.

The initiator is a ranging device that following the RCM, initiates a ranging exchange by sending the first message of the exchange which is the RIM (i.e., the ranging initiation message). In this example, the initiator may be the controller or a controlee. The responder is a ranging device that responds to the ranging initiation message received from the initiator, with a ranging response message (RRM).

As indicated, for a pair of ranging devices communicating with each other, the controller 900 is a ranging device that sends control information 902 to a receiving ranging device, designated as the controlee 904 in a ranging control phase 906. The control information 902 may include parameters for the UWB ranging session, such as timing, channel, etc. Although not illustrated, the controlee 904 can send an acknowledgment to the control information 902, may negotiate changes to the parameters, and/or the like.

The exchange between controller 900 and controlee 904, including the sending of the control information 902 and subsequent related exchanges between the controller 900 and the controlee 904 regarding control information, may be conducted OOB using different wireless communication technology (e.g., BLUETOOTH® or Wi-Fi®), prior to a ranging phase 908. Specifically, a UWB session may be associated with a control phase and a ranging phase, where the control phase (which may take place on an OOB link) comprises a preliminary exchange between controller 900 and controlee 904 of parameter values for the ranging phase, and the subsequent ranging phase includes the portion of the UWB session in which devices exchange messages within the UWB band for ranging measurements. It is appreciated, however, that some control information may be exchanged within the UWB band (e.g., a “ranging control phase” occurring in the first slot of a UWB round). Accordingly, some aspects of the control phase may be considered to occur in band, subsequent to the preliminary OOB exchange between the controller 900 and the controlee 904.

The UWB session may occur afterward, in accordance with the parameters provided in the control information. In the ranging phase of the UWB session, one ranging device may take the role of an initiator 910 and the other ranging device may take the role of a responder 912. As indicated in FIG. 9A, the initiator 910 may initiate UWB ranging by sending a ranging initiation message 914 to the responder 912, to which the responder 912 may reply with a ranging response message 916, and timing measurements may be made of these messages (by the devices receiving the messages) to perform two-way ranging (TWR). Depending on the parameters of the control information 902, additional exchanges may be made in the ranging phase between the initiator 910 and responder 912 to allow for additional ranging measurements.

In this example, the roles of initiator 910 and responder 912 may be indicated in the control information 902. Further, as indicated in FIG. 9A, the controller 900 in the ranging control phase 906 may be the initiator 910 in the ranging phase 908 of the UWB session. Alternatively, as indicated in FIG. 9B, the controller 900 in the ranging control phase 906 may be the responder 912 in the ranging phase 908. The determination of which device is initiator 910 and which is responder 912 may depend on the parameters set forth in the control information 902, in which case the controlee 904 correspondingly becomes either the responder 912 or the initiator 910. According to some embodiments, a controller/initiator may conduct ranging with multiple controlees/responders.

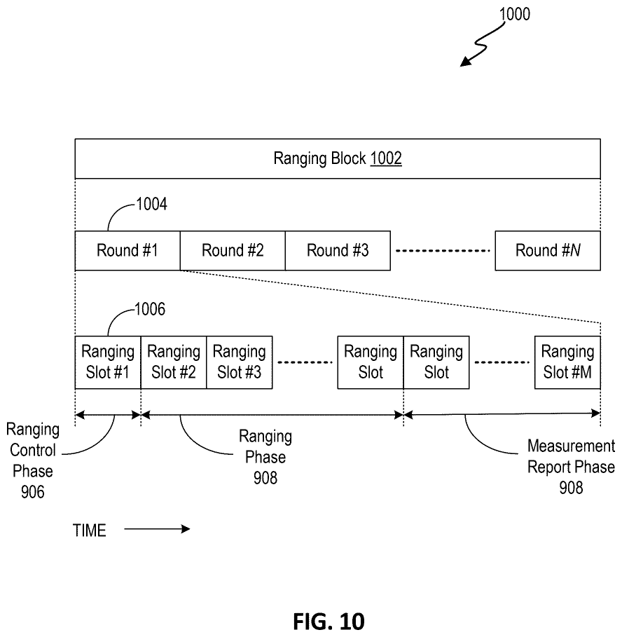

FIG. 10 is a diagram 1000 illustrating how time may be segmented and utilized within a UWB positioning session, which may be used in some embodiments. A UWB session may occur over a period of time divided into sub-portions according to a hierarchical structure. This timing comprises one or more consecutive ranging blocks 1002, which may have a configurable duration (e.g., 200 ms). For simplicity and ease of illustration, only one ranging block 1002 is shown in FIG. 10. However, it is appreciated that a UWB session may utilize multiple blocks, which may occur in succession. Also, although called “ranging” blocks 1002, they may be used for ranging and/or sensing. Each ranging block 1002 may be split into one or more successive rounds 1004 (e.g., N rounds). The number and length of the rounds may be configurable. The rounds 1004 may be further split into different ranging slots 1006 (also referred to simply as “slots”), which also may have a configurable number and length (e.g., 1-2.66 ms). As an example, multiple rounds may be used for interference handling. For example, a given responder may transmit a message (i.e., a data packet) within only a single round per block, and the round index may either be statistically configured by the controller 900 or selected per a hopping pattern. In general, the UWB session utilizing Time Division Multiplexing (TDM) communication for communicating between the different UWB devices based on the IEEE 802.15.4 standards for UWB.

The ranging slots within round 1004 may be allocated for different purposes. For example, the initial ranging slot may be dedicated as the ranging control phase 906 (i.e., where the controller 900 transmits the RCM), in which an initiator UWB device (e.g., an initiator anchor), transmits control information for the other UWB devices participating in a UWB session (e.g., responder anchors and/or other UWB devices). This information can include, for example, an allocation of ranging slots among the different responder devices. During the subsequent ranging phase 908, the different responder may transmit in accordance with the allocated slot. That is, each responder may be allocated a corresponding slot in the ranging phase 908 to transmit one or more ranging/sensing signals. In this example, a ranging packet duration may utilize the SP3 format that is about 150 microseconds such that the remainder of the slot (i.e., a “gap”) may be retained for processing delays and/or reply messages such as RRM.

The ranging phase 908 may be followed by a measurement report phase 1008 in which UWB anchors in a cluster may report measurements (e.g., of signals measured during the ranging phase 908). Sequential ranging slots may be used to perform Single-Sided Two-Way Ranging (SS-TWR) or DS-TWR, for example. Multiple UWB sessions can be time-multiplexed to help prevent interference with one another.

In general, the RIM and RRM include preambles and data sequences that can be correlated to get TOA values. In these examples, the individual ranging slots 1006 are utilized for transmission of ranging packets and the first ranging slot (i.e., ranging slot #1) is reserved for the RCM. In this example, only a single ranging round 1004 is selected within ranging block 1002 and the other ranging rounds may be idle. This helps prevent interference from multiple UWB seasons operating in the vicinity so as to reduce the likelihood of interference.

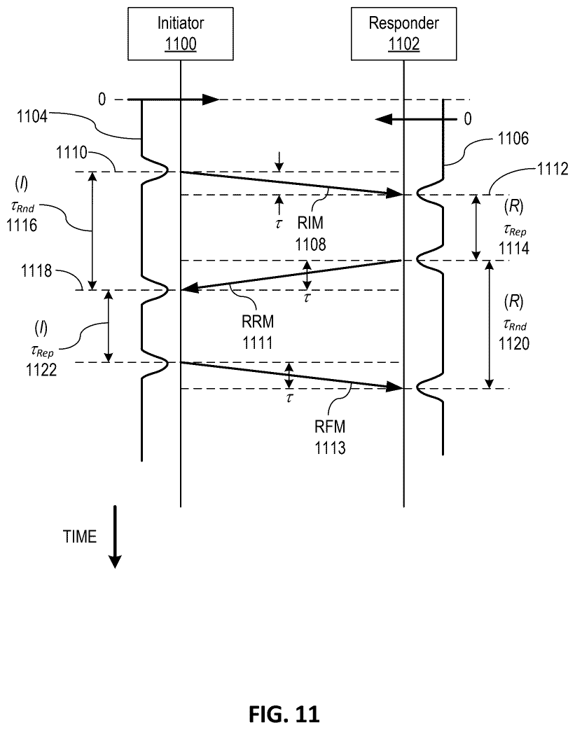

FIG. 11 is a signal flow diagram of communications between the first ranging device (acting as an initiator 1100) and the second ranging device (acting as a responder 1102) in accordance with the present disclosure. In this example, the initiator 1100 is shown transmitting and receiving signals 1104 and the responder 1102 is shown receiving and transmitting signals 1106. The pulses shown on the signals 1104 and 1106 illustrate the timing of transmissions between the initiator 1100 and responder 1102.

In general, the there is a lag between the first signal 1104 and second signal 1106 as shown with the “0” marked on the first signal 1104 as compared to the “0” marked on the second signal 1106 that are not aligning. This means that the “0” that the initiator 1100 maintains in its local clock (i.e., its local time reference) is lagging the local reference that the responder 1102 maintains. As such, when an TOA estimate is generated it will have an error called a “clock offset” error. In addition to the clock offset error, this example of operation also generally introduces a carrier frequency offset/error that is related to the modulation frequency acting on the carrier frequency of operation of the channel that both the initiator 1100 are responder 1102 are utilizing. In general, the use of a third data packet message will eliminate these problems by utilizing DS-TWR. In this example, the third data packet message may be Reply Final Message (RFM) which is an RRM.

FIG. 11 illustrates the impact of carrier frequency offset on TOA estimations because there is a time delay (t) between the signals 1104 from the initiator 1100 reaching the responder 1102 and the signals 1106 from the responder 1102 reaching the initiator 1100. Specifically, an RIM 1108 transmitted as part of the signal 1104 (as shown by the pulse at a first time 1110) reaches the responder 1102 at a second time 1112 (as shown by the pulse on the signal 1106) that is delayed by a propagation delay t. Likewise, both the RRM 1111 and RFM 1113 are each also delay by t. As such, if the responder 1102 has transmission delay (t rep) 1114 in responding with the RRM 1111 after receiving the RIM 1108, the round-trip time (τ Rnd) 1116 from the transmission of the RIM 1108 at the first time 1110 to the time 1118 that the RRM 1111 is received by the initiator 1100 is the summation of the τ rep 1114 plus twice the propagation delay τ. Similarly, the round-trip time (τ Rnd 1120) from the time that RRM 1111 is transmitted to the initiator 1100 and a ranging final message (RFM) 1113 is received from the initiator is the summation of the transmission delay (τ rep 1122) of the initiator 1100 plus twice the propagation delay τ. With these values, both the SS-TWR and DS-TWR may be calculated. Additionally, the relative clock drift rate, initiator carrier frequency error, responder carrier frequency error may also be calculated.

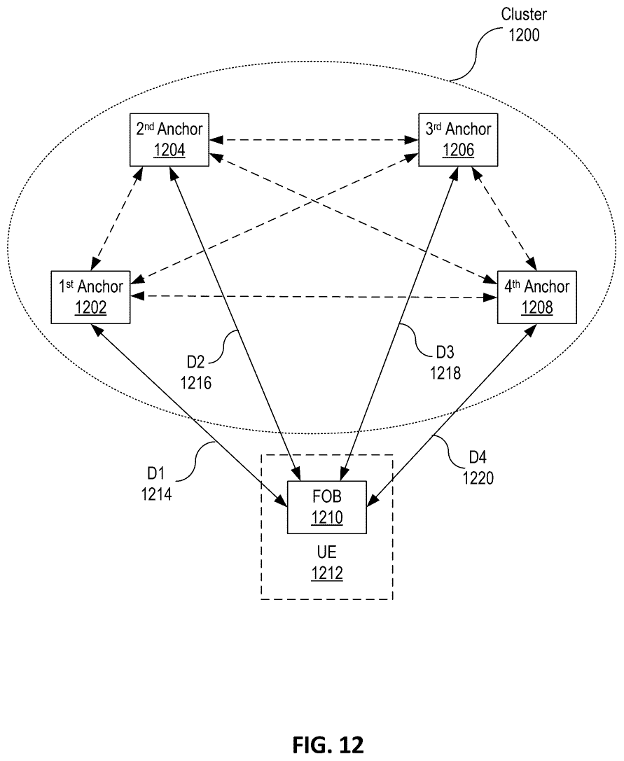

In FIG. 12, a functional system block diagram illustrating an example of a cluster 1200 of anchors is shown in accordance with the present disclosure. In this example, cluster 1200 may include, for example, four anchors (i.e., first anchor 1202, second anchor 1204, third anchor 1206, and fourth anchor 1208) that are in signal communication with each other and with the FOB 1210 that may be, for example, a part of an optional UE 1212. In this example, the four anchors can determine the location of a FOB 1210 using ranging to determine values for distances D1 1214, D2 1216, D3 1218, and D4 1220, based on known UWB ranging techniques. In particular, the cluster 1200 may allow for the positioning of the FOB 1210 using TDOA measurements in UWB. Specifically, the FOB 1210 can, for each anchor in the cluster 1200, precisely measure the reception time of a message (e.g., downlink TDOA messages) sent by the anchor. Using reception times and obtained coordinates of the anchors, the FOB 1210 may estimate its position. For a cluster 1200 providing the TDOA, the FOB 1210 and anchors of a cluster 1200 may be respectively referred to as a downlink TDOA (DT)-tag and DT-anchors. In this example, the positioning supported by a cluster 1200 made in accordance with applicable standards by FiRa™, the standards organization comprising a consortium of multiple member entities developing standards for UWB ranging and positioning.

In this example, the cluster 1200 may be a set of anchors (i.e., first anchor 1202, second anchor 1204, third anchor 1206, and fourth anchor 1208) that exchange messages with each other to provide a localization service. As an example, OOB messaging (e.g., OOB configuration messages sent via BLUETOOTH® or Wi-Fi®) may be sent by an Init-anchor (e.g., first anchor 1202) to create the cluster 1200 of anchors within a cluster area. To support TDOA positioning, the anchors may provide ranging messages with each other to provide TDOA localization to DT-tags.

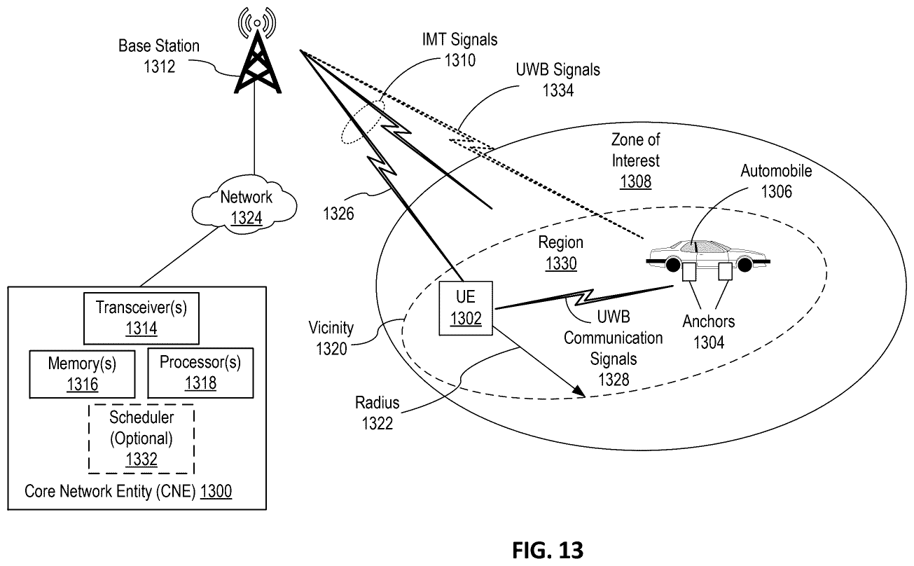

Turning to FIG. 13, a system block diagram is shown of an example of an implementation of a Network Entity 1300, UE 1302, and a plurality of anchors 1304 conformally located around an automobile 1306 in a zone of interest 1308. In this example, the Network Entity 1300 is configured to infer a presence of UWB sessions within the zone of interest 1308 for coexistence with IMT signals 1310 (i.e., non-UWB signals that are cellular signals) transmitted and/or received by a base station 1312 of a cellular system. The Network Entity 1300 may be, for example, a server (e.g., the server 400 described previously in relation to FIG. 4), remote entity, or a device, component, or other module or function of, for example, the 5GC 140 described earlier in relation to FIG. 1. The Network Entity 1300 may comprise at least one transceiver 1314, at least one memory 1316, and at least one processor 1318, in signal communication with the at least one transceiver 1314, and the at least one memory 1316. The at least one processor 1318 may be configured to: receive, with the at least one transceiver 1314, a plurality of UWB session reports from a plurality of UEs within the zone of interest 1308, where each UWB session report includes an indication of UWB activity in a vicinity 1320 of a corresponding UE (e.g., UE 1302); generate a heatmap of the zone of interest 1308 by aggregating the plurality of UWB session reports; and schedule transmission, reception, or both, of non-interfering non-UWB signals in the zone of interest.

In this example, the vicinity 1320 of the UE 1302 may be, for example, a circular area of radius 1322 that extends outward from the UE 1302 within the zone of interest 1308. It is appreciated that while the vicinity 1320 is illustrated as having an elliptical shape, this is for the purposes of illustration only within FIG. 13 and that shape of the vicinity 1320 is circular with the automobile 1306 being located within the radius 1322 of the vicinity 1320.

The UE 1302 may be, for example, a communication device that is, or includes, a UWB device such as, for example, either the first ranging device 500 or the second ranging device 502 described previously in relation to FIG. 5. As an example, the UE 1302 may be, for example, the UE 200 or the TRP 300 previously described in relation to FIGS. 2 and 3, respectively. As a further example, of the UE 1302 may also include a mobile device, such as a cellular telephone, or a roadside unit (RSU) that is fixed along a road or other structure. If the UE 1302 is an RSU, the RSU may be a wireless communication device located on the side of the road that is configured to provide connectivity and information to the passing vehicles along the road. The RSU may include one or more sensors that include, for example, a camera, an acoustic sensor, or other types of sensors. The RSU may transmit a plurality of signals related to, for example, the acquired sensor data of the environment surrounding the road within the vicinity 1320 of the RSU.

In this example, the Network Entity 1300 may be in signal communication with base station 1312 via a communication network 1324 and the UE 1302 via the communications network 1324 and base station 1312. The UE 1302 may communicate with a cellular network and the Network Entity 1300, in particular, via a signal path 1326 of the IMT signal 1310 transmissions between the UE 1302 and the base station 1312. The UE 1302 may also communicate with the plurality of anchors 1304 via UWB communication signals 1328 within the zone of interest 1308.

As described previously, because of the overlap of the frequency band of operation of both the IMT signal 1310 transmissions and the UWB communication signals 1328, there is the possibility that the IMT signal 1310 transmissions may interfere with the UWB communication signals 1328 because generally the power levels of the IMT signal 1310 transmission are much larger than the power levels of the UWB communication signals 1328. As such, the Network Entity 1300 is configured to reduce the interference of the UWB communication signals 1328 by allocating non-interfering cellular signal resources to the zone of interest 1308, where allocating non-interfering cellular signal resources includes scheduling transmission, reception, or both, of non-interfering non-UWB signals (e.g., IMT signals 1310) in the zone of interest 1308. In this example, the Network Entity 1300 first receives a plurality of UWB session reports from a plurality of UEs (including UE 1302) within the zone of interest 1308, where each UWB session report includes an indication of UWB activity in the vicinity (e.g., the vicinity 1320) of a corresponding UE (i.e., UE 1302). It is appreciated that while only a single UE (i.e., UE 1302) is show, this is for the purposes of ease of illustration and that there could be a plurality of UEs located within the zone of interest 1308 and that the individual UEs of the plurality of UEs may be within the zone of interest 1308 at different times. As an example, the plurality of UEs may be crowdsourced UEs that may be present within the zone of interest 1308 at various times. Moreover, there may be more anchors (beyond the shown plurality of anchors 1304) located within the zone of interest 1308. As an example, if the zone of interest 1308 is a city street or parking lot, there may be a plurality of vehicles (that include automobile 1306) each having a plurality of anchors capable of transmitting and receiving UWB signals within the zone of interest 1308.

In this example, the at least one processor 1318 may be configured to receive the plurality of UWB session reports via a Long-Term Evolution (LTE) Positioning Protocol Extensions (LPPe).

Further, the plurality of UEs (including UE 1302) may be crowdsourced UEs such that different UE located within different locations and times within the zone of interest 1308 may detect, receive, and measure the presence and intensity of UWB sessions at the different locations and times within the zone of interest 1308. As such, the Network Entity 1300 is configured to receive the receive the plurality of UWB session reports over a first time duration, and generate the heatmap of the zone of interest 1308 by aggregating the plurality of UWB session reports over the first time duration. In this example, the first time duration may vary based on the desired accuracy of the heatmap.

In this disclosure, a “heatmap” is a two-dimensional of data that represents the magnitude of individual data values within an area. Specifically, the heatmap discussed is a database of UWB session intensity valves along an area such as the zone of interest 1308 or at least one region (e.g., region 1330) within a vicinity (e.g., vicinity 1320) of a UE (e.g., UE 1302) of the zone of interest 1308. The database of the heatmap may be stored within the at least one memory 1316.

In this example, the heatmap may indicates at least one region (e.g., region 1330) within the zone of interest 1308 where the UWB sessions are susceptible to interference from the IMT signals 1310 (i.e., non-UWB signals that are cellular signals) based on the received plurality of UWB session reports over the first time duration, and the at least one region may include a physical size that is within the vicinity (e.g., vicinity 1320) of the corresponding UE (e.g., UE 1302), and the UWB session intensity of a detected UWB session within the at least one region. In this example, the UWB session intensity within the at least one region and physical size of the at least one region may vary with time since the measured UWB session intensity and location measured by different crowdsourcing UEs at different locations and times within the zone of interest 1308 will generally be different over time.

The Network Entity 1300 may then be configured to schedule transmission, reception, or both, of non-interfering non-UWB signals (e.g., IMT signals 1310) in the zone of interest 1308. In this example, the schedule of transmission of non-UWB signals is configured to schedule the transmission of the non-UWB signals (e.g., IMT signals 1310) from an at least one base station (e.g., base station 1312) to the zone of interest 1308 within a threshold distance of the at least one region (e.g., region 1330). As an example, the threshold distance may be based on the radius (e.g., radius 1322) around the location of the UE (e.g., UE 1302) detecting, receiving, and measuring the UWB session messages (i.e., RCMs) from UWB devices (e.g., the plurality of anchors 1304) within the vicinity (e.g., vicinity 1320) of the UE. As an example, these RCMs may be broadcast by the UWB devices in the vicinity of the UE. Examples of these UWB devices may include key FOBs, vehicles, an entry door (e.g., to a building) and gate locks, and other UEs. As an example, the corresponding UE located within the zone of interest 1308 may periodically scan for the UWB session configuration messages (i.e., RCM) that may be broadcast by the UWB devices.

In this example, relevant fields may be extracted from the UWB session configuration messages to create a time, frequency, and spatial resource allocation information element. The spatial resource allocation information element generally captures and describes a time, frequency, and spatial nature of the UWB activity within the at least one region. As an example, the spatial resource allocation information element may include expected time durations of UWB activity based on the ranging interval, round index, and initiation time; expected frequency bands that may be used for UWB activity based on the channel number that was advertised by the broadcasting UWB devices; and expected region of UWB activity that may be defined by the threshold radius around the current location of the UE, where the radius is proportional to the signal strength of the UWB session configuration message.

As an example, the relevant fields that may be extracted from the UWB session configuration messages may include parameters that are described in of the UWB MAC specification (e.g., IEEE 802.15.4ab). For example, some relevant parameters include: whether the device is a controller or controlee; channel number; UWB initiation time that represents when the ranging block is going to begin and is the time reference for the entire session; ranging interval/block duration; round duration; slot duration; and whether round hopping is enabled or disabled.

The UWB session report may also include other metrics that may be inferred from the UWB session configuration message, such as, for example, mobility information (i.e., whether the UWB device was moving or stationary), and device type (i.e., whether it is a vehicle, an entry door, or a key FOB).

In this example, the Network Entity 1300 may be further configured to update the heatmap based on received UWB session reports from crowdsourced UEs that are received after the first time duration.

Further, the Network Entity 1300 may also be configured to schedule transmission, reception, or both, of non-interfering non-UWB signals (e.g., IMT signals 1310) in the zone of interest 1308. In this example, the Network Entity 1300 may allocate non-interfering cellular signal (e.g., IMT signals 1310) resources by being configured to create a schedule of the transmission of the cellular signals from cellular signal resources that are non-overlapping with UWB configuration messages corresponding to the plurality of UWB session reports. In this example, the schedule of the transmission of the non-interfering non-UWB signals may be created by the at least one processor 1318 utilizing software or by an optional scheduler 1332 that may be a device, component, or module of the Network Entity 1300. In this example, the Network Entity 1300 may be further configured to transmit, with the at least one transceiver 1314, the schedule of transmission to at least one base station (e.g., base station 1312) that is configured to transmit the IMT signals 1310 (i.e., the cellular signals) to the zone of interest 1308 that may include the at least one region (e.g., region 1330). The Network Entity 1300 may also transmit the schedule of transmission to the plurality of UEs (including the UE 1302).

As discussed previously, each UWB session report of the plurality of UWB session reports includes at least one RCM for at least one UWB device within the vicinity (e.g., vicinity 1320) of the corresponding UE (e.g., UE 1302).

In this example, it is appreciated that if the base station 1312 is located close enough to the zone of interest 1308, the base station 1312 may also be able to detect, receive, and transmit UWB signals 1334 between the base station 1312 and the plurality of anchors 1304.

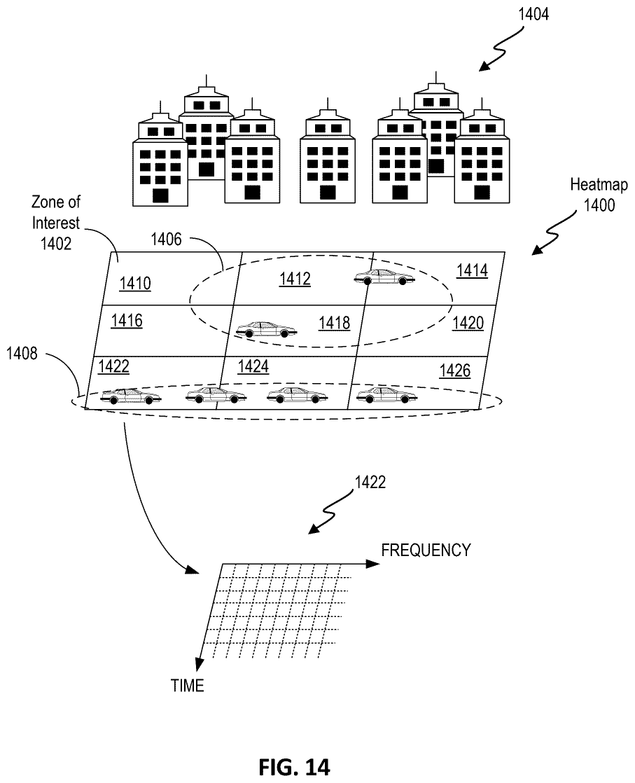

FIG. 14 is a system block diagram of an example of an implementation of a heatmap 1400 illustrating UWB session activity over a zone of interest 1402. In this example, the zone of interest 1402 is shown along an example city street/road within a city having buildings 1404 and moving vehicles 1406 and parked vehicles 1408 along a side of the street. In this example, the heatmap 1400 is generated by aggregating multiple UWB session reports at the Network Entity 1300 over a time duration to create the heatmap 1400 of potential UWB activity within the zone of interest 1402 based on historically received UWB session reports from crowdsourced UEs that were located within the zone of interest 1402.

As an example, the multiple UWB session reports may be combined at the Network Entity 1300 to create an overall time and frequency grid of potential UWB activity for a given region within a region of the zone of interest 1402. This grid may extend over the duration of several IMT frames, may be periodic, and may be updated periodically by the Network Entity 1300 over time (i.e., over a time duration). As an example, the region of the zone of interest 1402 may be divided into nine (9) titles shown as tiles 1410, 1412, 1414, 1416, 1418, 1420, 1422, 1424, and 1426. In this example, the tile sizes may be dependent on the nature of the broader area where the zone of interest 1402 is located. As an example, smaller tiles may be utilized in a dense urban area, while larger tiles may be utilized in a rural area because generally a dense urban area will have more UWB devices along the zone of interest 1402 as compared to an urban area. In this example, the heatmap 1400 may be categorized or discretized over a number of “levels” that capture the susceptibility of a certain area/region within the zone of interest 1402 to IMT interference. In this example, each tile (i.e., tile 1410, 1412, 1414, 1416, 1418, 1420, 1422, 1424, and 1426) may be associated with a susceptibility level that in turn depends on: the number of unique UWB session reports that indicate a region which overlaps with the tile; an overall duty cycle of UWB activity (i.e., a fraction of time when an active UWB transmission may occur); and a mobility and device type, where stationary devices such as parked vehicles or building doors would see persistent UWB activity. In this example, an expanded view of the tile 1422 is shown where a time and frequency grid is maintained to indicate the potential for UWB session activity. As an example, for a given tile or some region, there may be a corresponding time and frequency grid that represents the activity of UWB sessions. For example, UWB sessions may be performed over frequencies that are close to 8 GHz every 5 seconds, or close to 6.5 GHz every 100 ms. In this example, the time and frequency grid is utilized to capture such behavior, with very fine granularity (i.e., megahertz in the case of frequency, and milliseconds in the case of time).

In these examples, the UWB session reports include a format that may be integrated into LPP and/or NRPP. Specifically, the format of the UWB session reports may be incorporated into the upcoming releases of Section 6.5 of TS 37.355 (LPP) that includes a list of positioning techniques using NR and other technologies such as sensors, Wi-Fi®/WLAN®, and BLUETOOTH®. Below in Table 1, a sample element format for a UWB session report is shown.

TABLE 1

| Parameter | Description/Value |
|---|---|
| UWB session ID | Hexadecimal value, up to 128 bits in size |
| UWB device role | Controllee vs Controller (0/1) |
| UWB device type | Stationary vs Ad hoc stationary vs mobile (0/1/2) |
| Ranging block interval | 100-5000 ms in multiples of 10 ms |
| UWB Initiation time | 0-1000 ms in multiples of 10 ms |
| Round hopping | Static vs Dynamic (0/1) |
| Round index | If static, index in integer format, else, |
| | not applicable |
| Channel number | Integer format (5-14) |
| RSSI | Integer format |
| Region of coverage | Latitude/Longitude coordinates of center |
| | of a circular region of the expected |
| | coverage, along with a radius for the |
| | said region (in meters) |

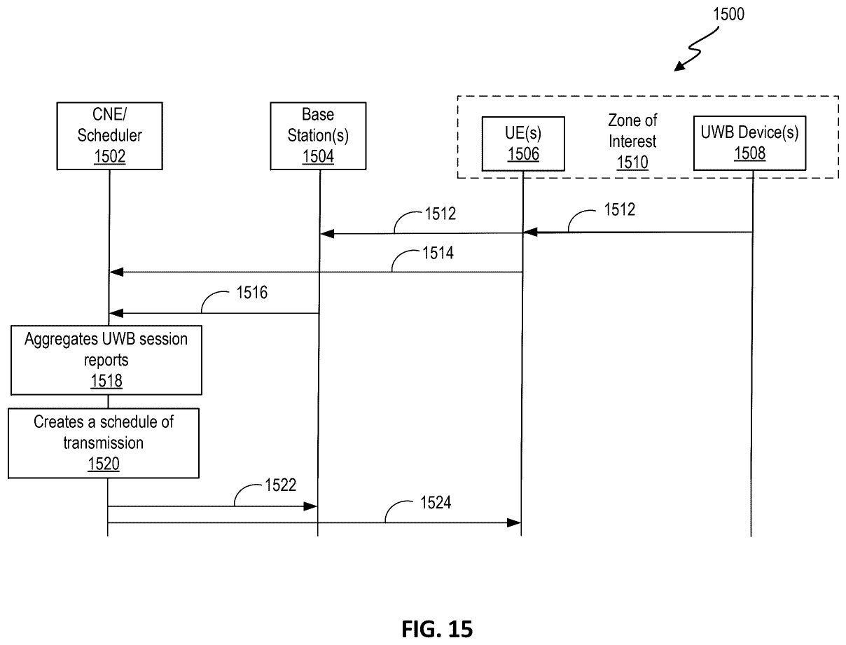

Turning to FIG. 15, a sequence diagram 1500 is shown illustrating an example of an implementation of operation of the Network Entity 1300 shown in FIG. 13. In this example, signals are transmitted and received back and forth between the Network Entity 1502 (e.g., the Network Entity 1300 or a scheduler 1332), at least one base station 1504, a plurality of UEs 1506, and a plurality of UWB devices 1508. In this example, both the plurality of UEs 1506 and plurality of UWB devices 1508 are located within the zone of interest 1510.

In an example of operation, the plurality of UEs 1506 receive UWB session configuration messages 1512. If the at least one base station 1504 is within the zone of interest 1510 and includes a UWB transceiver, the at least one base station 1504 may also receive the UWB session configuration messages 1512. Once the plurality of UEs 1506 receives the UWB session configuration messages 1512, the plurality of UEs 1506 create a plurality of UWB session reports and transmit 1514 the UWB session reports as, for example, an LPP to the Network Entity 1502. Additionally, if the at least one base station 1504 received the UWB session configuration messages 1512, the at least one base station 1504 may also create a UWB session report and transmits 1516 the UWB session report as, for example, an LPP to the Network Entity 1502. Once the Network Entity 1502 receives the UWB session reports (i.e., from the plurality of UEs 1506 and/or at least one base station 1504), the Network Entity 1502 aggregates 1518 the received UWB session reports and for a given tile and/or region, creates and/or updates a time and/or frequency grid that captures the potential UWB session activity. The Network Entity 1502 then creates 1520 non-overlapping IMT schedules based on the UWB time and/or frequency grid. The Network Entity 1502 then transmits 1522 the IMT schedule to the at least one base station 1504 and also, optionally, transmits 1524 the IMT schedule to the plurality of UEs 1506, where the IMT schedule may be transmitted as part of the DCI and/or PDCCH.

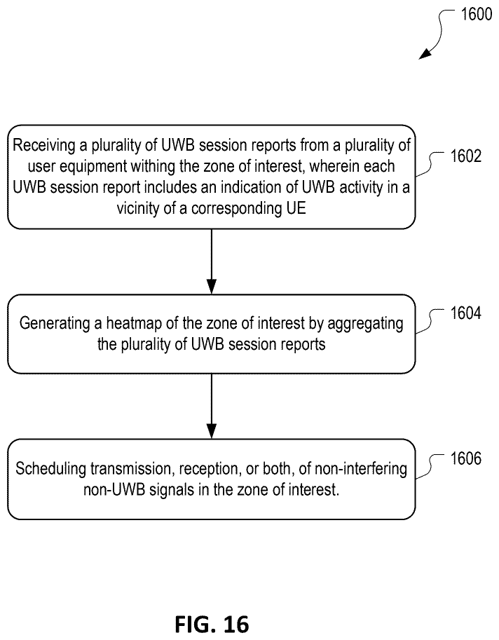

FIG. 16 is a flowchart of an example of an implementation of a method 1600 for inferring a presence of UWB sessions within a zone of interest (i.e., zone of interest 1308) for coexistence with non-UWB signals (i.e., cellular signals such as IMT signals 1310) with a Network Entity (i.e., Network Entity 1300). In this example, the method 1600 may comprise: at stage 1602, receiving a plurality of UWB session reports from a plurality of UEs within the zone of interest, where each UWB session report includes an indication of UWB activity in a vicinity (i.e., vicinity 1320) of a corresponding UE (i.e., UE 1302); at stage 1604, generating a heatmap of the zone of interest by aggregating the plurality of UWB session reports; and, at stage 1606, scheduling transmission, reception, or both, of non-interfering non-UWB signals (e.g., IMT signals 1310) in the zone of interest (i.e., zone of interest 1308 or 1402). The at least one transceiver 1314, possibly in combination with the at least one processor 1318, at least one memory 1316, or both, may comprise means for receiving a plurality of UWB session reports from the plurality of UEs within the zone of interest, where each UWB session report includes an indication of UWB activity in the vicinity (i.e., vicinity 1320) of the corresponding UE (i.e., UE 1302). The at least one processor 1318, possibly in combination with the at least one memory 1316 may comprise means for generating the heatmap of the zone of interest by aggregating the plurality of UWB session reports. The at least one processor 1318, possibly in combination with the at least one memory 1316 may comprise means for scheduling transmission, reception, or both, of the non-interfering non-UWB signals (e.g., IMT signals 1310) in the zone of interest (i.e., zone of interest 1308 or 1402).

In this example, receiving, at stage 1602, the plurality of UWB session reports may include receiving the plurality of UWB session reports via a LPPe. The plurality of UEs may be crowdsourced UEs that are within the zone of interest at different times. Receiving the plurality of UWB session reports may include receiving the plurality of UWB session reports over a first time duration, and generating the heatmap of the zone of interest (e.g., zone of interest 1402) may include aggregating the plurality of UWB session reports over the first time duration.

In this example, the heatmap 1400 may indicate at least one region within the zone of interest (e.g., zone of interest 1308 or 1402) where the UWB sessions are susceptible to interference from the non-UWB signals (i.e., IMT signals 1310) based on the received plurality of UWB session reports over the first time duration, and the at least one region (e.g., region 1330) includes a physical size that is within the vicinity (e.g., vicinity 1320) of the corresponding UE, and a UWB session intensity of a detected UWB session within the at least one region.

In this example, at stage 1606, scheduling transmission, reception, or both, of non-interfering non-UWB signals (e.g., IMT signals 1310) in the zone of interest (e.g., zone of interest 1308 or 1402) may include scheduling transmission of the non-interfering non-UWB signals that are non-overlapping with UWB configuration messages corresponding to the plurality of UWB session reports, and creating the schedule of transmission of the non-interfering non-UWB signals may include scheduling transmission of the non-interfering non-UWB signals from at least one base station (e.g., base station 1312) to the zone of interest (e.g., zone of interest 1308) within a threshold distance of the at least one region (e.g., region 1330). As discussed previously, the non-UWB signals may be cellular signals that include 4G, 5G, and 6G cellular signals, such as, for example, IMT signals 1310.

In this example, the method 1600 may further include updating the heatmap (e.g., heatmap 1400) based on received UWB session reports from crowdsourced UEs that are received after the first time duration. Further, the schedule of transmission may be transmitted to the plurality of UEs and a UWB session report of the plurality of UWB session reports includes at least one RCM for at least one UWB device within the vicinity (e.g., vicinity 1320) of the corresponding UE (e.g., UE 1302).

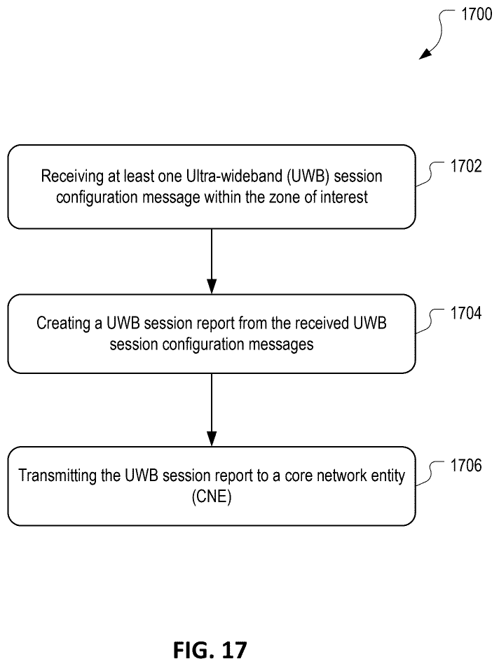

FIG. 17 is a flowchart of an example of an implementation of a method 1700 for inferring a presence of UWB sessions within a zone of interest for coexistence with non-UWB signals with a UE. In this example, the method 1700 may comprise: at stage 1702, receiving at least one UWB session configuration message within the zone of interest; at stage 1704, creating a UWB session report from the received UWB session configuration messages; and, at stage 1706, transmitting, with the at least one transceiver, the UWB session report to the Network Entity.

The at least one transceiver 510 or 516, possibly in combination with the at least one processor 514 or 520, at least one memory 512 or 518, and/or optional non-UWB transceiver 526 or 528, may comprise means for receiving at least one UWB session configuration message within the zone of interest. The at least one processor 514 or 520, possibly in combination with the at least one memory 512 or 518 may comprise means for creating a UWB session report from the received UWB session configuration messages. The at least one transceiver 510 or 516, possibly in combination with the at least one processor 514 or 520, at least one memory 512 or 518, or both, may comprise means for transmitting the UWB session report to the Network Entity.

More specifically, the UE (e.g., UE 1302) may be either a controller (e.g., controller 900) or a controlee (e.g., controlee 904) that include hardware and/or software such that the UE may include either the first ranging device 500 or second ranging device 502. In this example, the means for receiving the at least one UWB session configuration message within the zone of interest may be either the at least one transceiver 510 or the optional non-UWB transceiver 526 of the first ranging device 500, or the at least one transceiver 516 or optional non-UWB transceiver 528 of the second ranging device 502 possibly in combination with the corresponding at least one processor 514 or 520 and the at least one memory 512 or 518. The means for creating a UWB session report from the received UWB session configuration messages may include the at one processor 514 of the first ranging device 500, or the at one processor 520 of the second ranging device 502. Further, the means for transmitting the UWB session report to the Network Entity (e.g., Network Entity 1300) may include the at least one transceiver 510 of the first ranging device 500, or the at least one transceiver 516 of the second ranging device 502 possibly in combination with the corresponding at least one processor 514 or 520 and the at least one memory 512 or 518.

In this example, the UE may be a crowdsouced UE that transmits the UWB session report to the Network Entity a first time duration. As an example, UWB session report may include at least one RCM for the UWB device within the vicinity of the corresponding UE. Further the UE may transmit the UWB session report via a LLPe.

### IMPLEMENTATION EXAMPLES

Implementation examples are provided in the following numbered clauses.

Clause 1. A Network Entity for inferring a presence of Ultra-wideband (UWB) sessions within a zone of interest, the Network Entity comprising: at least one transceiver; at least one memory; and at least one processor, in signal communication with the at least one transceiver, and the at least one memory, the at least one processor configured to: receive, with the at least one transceiver, a plurality of UWB session reports from a plurality of user equipments (UEs) within the zone of interest, wherein each UWB session report includes an indication of UWB activity in a vicinity of a corresponding UE; generate a heatmap of the zone of interest by aggregating the plurality of UWB session reports; and schedule transmission, reception, or both, of non-interfering non-UWB signals in the zone of interest.

Clause 2. The Network Entity of clause 1, wherein the at least one processor is configured to receive the plurality of UWB session reports via a Long-Term Evolution Positioning Protocol Extension (LPPe).

Clause 3. The Network Entity of clause 1, wherein the plurality of UEs are within the zone of interest at different times, and the at least one processor is configured to receive the plurality of UWB session reports over a first time duration, and generate the heatmap of the zone of interest by aggregating the plurality of UWB session reports over the first time duration.

Clause 4. The Network Entity of clause 3, wherein the heatmap indicates at least one region within the zone of interest where the UWB sessions are susceptible to interference from non-UWB signals operating at a frequency band that at least partially overlaps a UWB frequency band based on the received plurality of UWB session reports over the first time duration, and the at least one region includes a physical size that is within the vicinity of the corresponding UE, and a UWB session intensity of a detected UWB session within the at least one region.

Clause 5. The Network Entity of clause 4, wherein the at least one processor is configured to schedule transmission, reception, or both, of the non-interfering non-UWB signals in the zone of interest by being configured to create a schedule of transmission of the non-interfering non-UWB signals that are non-overlapping with UWB configuration messages corresponding to the plurality of UWB session reports, and create the schedule of transmission of the non-interfering non-UWB signals by being configured to schedule the transmission of the non-interfering non-UWB signals from at least one base station to the zone of interest within a threshold distance of the at least one region.

Clause 6. The Network Entity of clause 5, wherein the non-UWB signals are cellular signals that include fourth generation (4G), fifth generation (5G), and sixth generation (6G) cellular signals.

Clause 7. The Network Entity of clause 4, wherein the at least one processor is further configured to update the heatmap based on received UWB session reports received after the first time duration.

Clause 8. The Network Entity of clause 1, wherein the at least one processor is configured to schedule transmission, reception, or both, of the non-interfering non-UWB signals in the zone of interest by being configured to create a schedule of transmission of the non-interfering non-UWB signals that are non-overlapping with UWB configuration messages corresponding to the plurality of UWB session reports.

Clause 9. The Network Entity of clause 8, wherein the at least one processor is further configured to transmit, with the at least one transceiver, the schedule of transmission.

Clause 10. The Network Entity of clause 9, wherein the at least one processor is configured to transmit the schedule of transmission to at least one base station that is configured to transmit the non-interfering non-UWB signals to the zone of interest.

Clause 11. The Network Entity of clause 10, wherein the at least one processor is configured to transmit the schedule of transmission to the plurality of UEs.

Clause 12. The Network Entity of clause 1, wherein at least one of the plurality of UWB session reports includes at least one Range Control Message (RCM) for at least one UWB device within the vicinity of the corresponding UE.

Clause 13. A method for inferring a presence of Ultra-wideband (UWB) sessions within a zone of interest for coexistence with non-UWB signals with a Network Entity, the method comprising: receiving a plurality of UWB session reports from a plurality of user equipment (UEs) within the zone of interest, wherein each UWB session report includes an indication of UWB activity in a vicinity of a corresponding UE; generating a heatmap of the zone of interest by aggregating the plurality of UWB session reports; and scheduling transmission, reception, or both, of the non-interfering non-UWB signals in the zone of interest.

Clause 14. The method of clause 13, wherein receiving the plurality of UWB session reports includes receiving the plurality of UWB session reports via a Long-Term Evolution Positioning Protocol Extensions (LPPe).

Clause 15. The method of clause 13, wherein the plurality of UEs are within the zone of interest at different times, receiving the plurality of UWB session reports includes receiving the plurality of UWB session reports over a first time duration, and generating the heatmap of the zone of interest includes aggregating the plurality of UWB session reports over the first time duration.

Clause 16. The method of clause 15, wherein the heatmap indicates at least one region within the zone of interest where the UWB sessions are susceptible to interference from the non-UWB signals based on the received plurality of UWB session reports over the first time duration, and the at least one region includes a physical size that is within the vicinity of the corresponding UE, and a UWB session intensity of a detected UWB session within the at least one region.

Clause 17. The method of clause 16, wherein scheduling transmission, reception, or both, of the non-interfering non-UWB signals in the zone of interest by creating a schedule of transmission of the non-interfering non-UWB signals that are non-overlapping with UWB configuration messages corresponding to the plurality of UWB session reports, and creating the schedule of transmission of the non-interfering non-UWB signals includes scheduling the transmission of the non-interfering non-UWB signals from an at least one base station to the zone of interest within a threshold distance of the at least one region.

Clause 18. The method of clause 17, wherein the non-UWB signals are cellular signals that include fourth generation (4G), fifth generation (5G), and sixth generation (6G) cellular signals.

Clause 19. The method of clause 16, further comprising updating the heatmap based on received UWB session reports from crowdsourced UEs that are received after the first time duration.

Clause 20. The method of clause 13, wherein scheduling transmission, reception, or both, of the non-interfering non-UWB signals in the zone of interest by creating a schedule of transmission of the non-interfering non-UWB signals that are non-overlapping with UWB configuration messages corresponding to the plurality of UWB session reports.

Clause 21. The method of clause 20, further comprising transmitting the schedule of transmission.

Clause 22. The method of clause 21, wherein transmitting the schedule of transmission to at least one base station includes transmitting the non-interfering non-UWB signals to the zone of interest.

Clause 23. The method of clause 22, further comprising transmitting the schedule of transmission to the plurality of UEs.

Clause 24. The method of clause 13, wherein a UWB session report of the plurality of UWB session reports includes at least one Range Control Message (RCM) for at least one UWB device within the vicinity of the corresponding UE.

Clause 25. A user equipment (UE) for inferring a presence of Ultra-wideband (UWB) sessions within a zone of interest for coexistence with non-UWB signals, the UE comprising: at least one transceiver; at least one memory; and at least one processor, in signal communication with the at least one transceiver, and the at least one memory, the at least one processor configured to: receive, with the at least one transceiver, at least one Ultra-wideband (UWB) session configuration messages within the zone of interest; create a UWB session report from the received UWB session configuration messages; and transmit, with the at least one transceiver, the UWB session report to a Network Entity.

Clause 26. A method for inferring a presence of Ultra-wideband (UWB) sessions within a zone of interest for coexistence non-UWB signals with a user equipment (UE), the method comprising: receiving at least one Ultra-wideband (UWB) session configuration message within the zone of interest; creating a UWB session report from the received UWB session configuration messages; and transmitting the UWB session report to a Network Entity.

Clause 27. A Network Entity for inferring a presence of Ultra-wideband (UWB) sessions within a zone of interest, the Network Entity comprising: means for receiving a plurality of UWB session reports from a plurality of user equipment (UEs) within the zone of interest, wherein each UWB session report includes an indication of UWB activity in a vicinity of a corresponding UE; means for generating a heatmap of the zone of interest by aggregating the plurality of UWB session reports; and means for scheduling transmission, reception, or both, of the non-interfering non-UWB signals in the zone of interest.

Clause 28. The Network Entity of clause 27, wherein means for receiving the plurality of UWB session reports includes means for receiving the plurality of UWB session reports via a Long-Term Evolution Positioning Protocol Extensions (LPPe).

Clause 29. The Network Entity of clause 27, wherein the plurality of UEs are within the zone of interest at different times, means for receiving the plurality of UWB session reports includes means for receiving the plurality of UWB session reports over a first time duration, and means for generating the heatmap of the zone of interest includes means for aggregating the plurality of UWB session reports over the first time duration.

Clause 30. The Network Entity of clause 29, wherein the heatmap indicates at least one region within the zone of interest where the UWB sessions are susceptible to interference from the non-UWB signals based on the received plurality of UWB session reports over the first time duration, and the at least one region includes a physical size that is within the vicinity of the corresponding UE, and a UWB session intensity of a detected UWB session within the at least one region.

Clause 31. The Network Entity of clause 30, wherein means for scheduling transmission, reception, or both, of the non-interfering non-UWB signals in the zone of interest includes means for creating a schedule of transmission of the non-interfering non-UWB signals that are non-overlapping with UWB configuration messages corresponding to the plurality of UWB session reports, and means for creating the schedule of transmission of the non-interfering non-UWB signals includes means for scheduling the transmission of the non-interfering non-UWB signals from an at least one base station to the zone of interest within a threshold distance of the at least one region.

Clause 32. The Network Entity of clause 31, wherein the non-UWB signals are cellular signals that include fourth generation (4G), fifth generation (5G), and sixth generation (6G) cellular signals.

Clause 33. The Network Entity of clause 30, further comprising means for updating the heatmap based on received UWB session reports from crowdsourced UEs that are received after the first time duration.

Clause 34. The Network Entity of clause 27, wherein means for scheduling transmission, reception, or both, of the non-interfering non-UWB signals in the zone of interest includes means for creating a schedule of transmission of the non-interfering non-UWB signals that are non-overlapping with UWB configuration messages corresponding to the plurality of UWB session reports.

Clause 35. The Network Entity of clause 34, further comprising means for transmitting the schedule of transmission.

Clause 36. The Network Entity of clause 35, wherein means for transmitting the schedule of transmission to at least one base station includes means for transmitting the non-interfering non-UWB signals to the zone of interest.

Clause 37. The Network Entity of clause 36, further comprising means for transmitting the schedule of transmission to the plurality of UEs.

Clause 38. The Network Entity of clause 27, wherein a UWB session report of the plurality of UWB session reports includes at least one Range Control Message (RCM) for at least one UWB device within the vicinity of the corresponding UE.

Clause 39. A non-transitory processor-readable storage medium comprising processor-readable instructions configured to cause one or more processors of an Ultra-wideband (UWB) device to avoiding interference comprising: code for receiving a plurality of UWB session reports from a plurality of user equipment (UEs) within the zone of interest, wherein each UWB session report includes an indication of UWB activity in a vicinity of a corresponding UE; code for generating a heatmap of the zone of interest by aggregating the plurality of UWB session reports; and code for scheduling transmission, reception, or both, of the non-interfering non-UWB signals in the zone of interest.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed:

1. A Network Entity for inferring a presence of Ultra-wideband (UWB) sessions within a zone of interest, the Network Entity comprising:
at least one transceiver;
at least one memory; and
at least one processor, in signal communication with the at least one transceiver, and the at least one memory, the at least one processor configured to:
receive, with the at least one transceiver, a plurality of UWB session reports from a plurality of user equipments (UEs) within the zone of interest, wherein each UWB session report includes an indication of UWB activity in a vicinity of a corresponding UE;
generate a heatmap of the zone of interest by aggregating the plurality of UWB session reports; and
schedule transmission, reception, or both, of non-interfering non-UWB signals in the zone of interest.

2. The Network Entity of claim 1, wherein the at least one processor is configured to receive the plurality of UWB session reports via a Long-Term Evolution Positioning Protocol Extension (LPPe).

3. The Network Entity of claim 1, wherein
the plurality of UEs are within the zone of interest at different times, and
the at least one processor is configured to
receive the plurality of UWB session reports over a first time duration, and
generate the heatmap of the zone of interest by aggregating the plurality of UWB session reports over the first time duration.

4. The Network Entity of claim 3, wherein
the heatmap indicates at least one region within the zone of interest where the UWB sessions are susceptible to interference from non-UWB signals operating at a frequency band that at least partially overlaps a UWB frequency band based on the received plurality of UWB session reports over the first time duration, and
the at least one region includes
a physical size that is within the vicinity of the corresponding UE, and
a UWB session intensity of a detected UWB session within the at least one region.

5. The Network Entity of claim 4, wherein the at least one processor is configured to
schedule transmission, reception, or both, of the non-interfering non-UWB signals in the zone of interest by being configured to create a schedule of transmission of the non-interfering non-UWB signals that are non-overlapping with UWB configuration messages corresponding to the plurality of UWB session reports, and
create the schedule of transmission of the non-interfering non-UWB signals by being configured to schedule the transmission of the non-interfering non-UWB signals from at least one base station to the zone of interest within a threshold distance of the at least one region.

6. The Network Entity of claim 4, wherein the at least one processor is further configured to update the heatmap based on received UWB session reports received after the first time duration.

7. The Network Entity of claim 1, wherein the at least one processor is configured to schedule transmission, reception, or both, of the non-interfering non-UWB signals in the zone of interest by being configured to create a schedule of transmission of the non-interfering non-UWB signals that are non-overlapping with UWB configuration messages corresponding to the plurality of UWB session reports.

8. The Network Entity of claim 7, wherein the at least one processor is configured to transmit the schedule of transmission to at least one base station that is configured to transmit the non-interfering non-UWB signals to the zone of interest.

9. The Network Entity of claim 1, wherein at least one of the plurality of UWB session reports includes at least one Range Control Message (RCM) for at least one UWB device within the vicinity of the corresponding UE.

10. A method for inferring a presence of Ultra-wideband (UWB) sessions within a zone of interest for coexistence with non-UWB signals with a Network Entity, the method comprising:
receiving a plurality of UWB session reports from a plurality of user equipment (UEs) within the zone of interest, wherein each UWB session report includes an indication of UWB activity in a vicinity of a corresponding UE;
generating a heatmap of the zone of interest by aggregating the plurality of UWB session reports; and
scheduling transmission, reception, or both, of non-interfering non-UWB signals in the zone of interest.

11. The method of claim 10, wherein receiving the plurality of UWB session reports includes receiving the plurality of UWB session reports via a Long-Term Evolution Positioning Protocol Extensions (LPPe).

12. The method of claim 10, wherein
the plurality of UEs are within the zone of interest at different times,
receiving the plurality of UWB session reports includes receiving the plurality of UWB session reports over a first time duration, and
generating the heatmap of the zone of interest includes aggregating the plurality of UWB session reports over the first time duration.

13. The method of claim 12, wherein
the heatmap indicates at least one region within the zone of interest where the UWB sessions are susceptible to interference from the non-UWB signals based on the received plurality of UWB session reports over the first time duration, and
the at least one region includes
a physical size that is within the vicinity of the corresponding UE, and
a UWB session intensity of a detected UWB session within the at least one region.

14. The method of claim 13, wherein
scheduling transmission, reception, or both, of the non-interfering non-UWB signals in the zone of interest by creating a schedule of transmission of the non-interfering non-UWB signals that are non-overlapping with UWB configuration messages corresponding to the plurality of UWB session reports, and
creating the schedule of transmission of the non-interfering non-UWB signals includes scheduling the transmission of the non-interfering non-UWB signals from an at least one base station to the zone of interest within a threshold distance of the at least one region.

15. The method of claim 13, further comprising updating the heatmap based on received UWB session reports from crowdsourced UEs that are received after the first time duration.

16. The method of claim 10, wherein scheduling transmission, reception, or both, of the non-interfering non-UWB signals in the zone of interest by creating a schedule of transmission of the non-interfering non-UWB signals that are non-overlapping with UWB configuration messages corresponding to the plurality of UWB session reports.

17. The method of claim 16, wherein transmitting the schedule of transmission to at least one base station includes transmitting the non-interfering non-UWB signals to the zone of interest.

18. The method of claim 10, wherein a UWB session report of the plurality of UWB session reports includes at least one Range Control Message (RCM) for at least one UWB device within the vicinity of the corresponding UE.

19. A Network Entity for inferring a presence of Ultra-wideband (UWB) sessions within a zone of interest, the Network Entity comprising:
means for receiving a plurality of UWB session reports from a plurality of user equipment (UEs) within the zone of interest, wherein each UWB session report includes an indication of UWB activity in a vicinity of a corresponding UE;
means for generating a heatmap of the zone of interest by aggregating the plurality of UWB session reports; and
means for scheduling transmission, reception, or both, of non-interfering non-UWB signals in the zone of interest.

20. The Network Entity of claim 19, wherein
the plurality of UEs are within the zone of interest at different times,
means for receiving the plurality of UWB session reports includes means for receiving the plurality of UWB session reports over a first time duration, and
means for generating the heatmap of the zone of interest includes aggregating the plurality of UWB session reports over the first time duration.
